(19) United States
(12) Patent Application Publication
(10) Pub. No.: US 2026/0167480 A1
(43) Pub. Date: Jun. 18, 2026

(54) Supply Tank and Method for Operating Same

(71) Applicant: SK On Co., Ltd., Seoul (KR)

(72) Inventors: Seung Han LEE, Daejeon (KR); Hyung Gi KIM, Daejeon (KR)

(21) Appl. No.: 19/414,575

(22) Filed: Dec. 10, 2025

(30) Foreign Application Priority Data
Dec. 16, 2024 (KR) 10-2024-0187570

(51) Int. Cl. B67D 7/02; B67D 7/32; B67D 7/36

(52) U.S. Cl. CPC B67D 7/0294; B67D 7/32; B67D 7/36

(57) ABSTRACT

Proposed are a supply tank and a method for operating the same. The tank includes a body part configured to have a closed storage space inside, an injection part configured to communicate with the storage space and inject an object into the storage space, a supply part configured to communicate with the storage space and supply the object stored in the storage space to a next process, a discharge part configured to communicate with the storage space and discharge the object stored in the storage space to outside, a pressure maintenance valve connected to the storage space and configured to open or close in conjunction with one of the injection part, the supply part, and the discharge part, and a safety valve connected to the storage space, and configured to open above a set pressure and close below the set pressure.

### CROSS REFERENCE TO RELATED APPLICATION

The present application claims priority to Korean Patent Application No. 10-2024-0187570, filed Dec. 16, 2024, the entire contents of which is incorporated herein for all purposes by this reference.

### BACKGROUND

### Technical Field

The present disclosure relates to a supply tank and a method for operating the same.

### Description of the Related Art

In general, an electrolyte is a solution enabling the chemical reactions of a battery or a medium that facilitates the movement of lithium ions within a secondary battery.

Common examples of electrolytes include ammonium chloride solutions and diluted sulfuric acid.

The colorless and odorless electrolyte, diluted sulfuric acid, is prepared by mixing concentrated sulfuric acid with distilled water. The diluted sulfuric acid comes into contact with the electrodes and conducts electric current within the cell, thereby enabling the generation or storage of energy.

Because the efficiency of electrolysis is influenced by factors such as electrolyte composition, temperature, hydrogen ion concentration, and the presence and amount of impurities, it is essential to prepare an electrolyte that is suitable for the electrolysis process.

The electrolyte can then be stored in an electrolyte supply tank or another designated container and supplied to the secondary battery production process.

### DOCUMENT OF RELATED ART

(Patent Document 1) Korean Patent Application Publication No. 10-2024-0008281

### SUMMARY

According to an aspect of the present disclosure, provided is a supply tank and a method for operating the same, which enable metered discharge in a closed system and enhance safety.

According to another aspect of the present disclosure, provided is a supply tank and a method for operating the same, which can be widely applied to green technology fields including electric vehicles, battery charging stations, and various battery-powered solar and wind power generation systems.

In order to achieve the above objectives, according to an embodiment of the present disclosure, there is provided a supply tank including: a body part having a closed storage space inside; an injection part configured to communicate with the storage space and inject an object into the storage space; a supply part configured to communicate with the storage space and supply the object stored in the storage space to a next process; a discharge part configured to communicate with the storage space and discharge the object stored in the storage space to outside; a pressure maintenance valve connected to the storage space and configured to open or close in conjunction with one of the injection part, the supply part, and the discharge part; and a safety valve connected to the storage space, and configured to open above a set pressure and close below the set pressure.

The pressure maintenance valve may maintain a pressure of the storage space at a constant level.

The tank may further include a first flashback arrestor provided on a flow path of the pressure maintenance valve, and configured to prevent external flames from entering the flow path of the pressure maintenance valve.

The first flashback arrestor may be provided on the flow path of the pressure maintenance valve, and may extinguish flames that come into contact therewith by conducting heat away from the flames.

The tank may further include a second flashback arrestor provided on a flow path of the safety valve, and configured to prevent external flames from entering the flow path of the safety valve.

The second flashback arrestor may be provided on the flow path of the safety valve, and may extinguish flames that come into contact therewith by conducting heat away from the flames.

In order to achieve the above objectives, according to an embodiment of the present disclosure, there is provided a method for operating a supply tank, the method including: injecting an object into an internal storage space of a body part after opening an injection part and a pressure maintenance valve; discharging a portion of the object stored in the storage space to outside to remove bubbles in a state where a discharge part is open, with the injection part closed and the pressure maintenance valve kept open from the injecting of the object; and supplying the object stored in the storage space to a next process in a state where a supply part is open, with the discharge part closed and the pressure maintenance valve kept open from the discharging of the portion of the object.

When an internal pressure of the storage space of the body part exceeds a set pressure, a safety valve may open to lower the pressure of the storage space.

When the internal pressure of the storage space of the body part is below the set pressure, the safety valve may be closed.

In case that a flame enters a flow path of the safety valve from outside the body part, a second flashback arrestor provided on the flow path may lower temperature of the flame to extinguish the flame.

In case that a flame enters a flow path of the pressure maintenance valve from outside the body part, a first flashback arrestor provided on the flow path may lower temperature of the flame to extinguish the flame.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, it is possible to prevent the deterioration of the quality of the electrolyte stored inside.

Furthermore, the present disclosure can enable metered discharge in a closed system.

Furthermore, the present disclosure can enhance safety.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a schematic view of a supply tank according to an embodiment of the present disclosure;

FIG. 2 is a flowchart showing a method for operating a supply tank according to an embodiment of the present disclosure;

FIG. 3 is a view showing an injection step in a method for operating a supply tank according to an embodiment of the present disclosure;

FIG. 4 is a view showing a discharge step in a method for operating a supply tank according to an embodiment of the present disclosure; and

FIG. 5 is a view showing a supply step in a method for operating a supply tank according to an embodiment of the present disclosure.

### DETAILED DESCRIPTION

Terms used to describe an embodiment of the present disclosure are not intended to limit the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

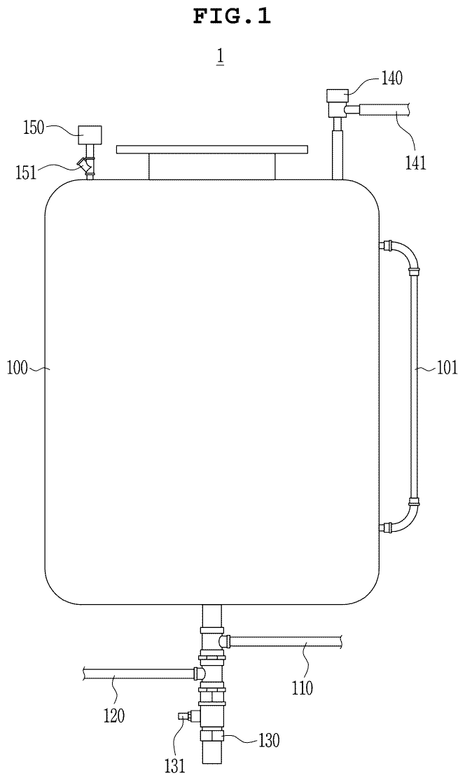

FIG. 1 is a schematic view of a supply tank according to an embodiment of the present disclosure.

Referring to FIG. 1, a supply tank 1 according to an embodiment of the present disclosure may include: a body part 100 having a closed storage space inside; an injection part 110 communicating with the storage space and injecting an object into the storage space; a supply part 120 that communicates with the storage space and supplies the object stored in the storage space to the next process; a discharge part 130 that communicates with the storage space and discharges the object stored in the storage space to the outside; a pressure maintenance valve 140 that is connected to the storage space and opens or closes in conjunction with one of the injection part 110, the supply part 120, and the discharge part 130; and a safety valve 150 that is connected to the storage space, and opens above a set pressure and closes below the set pressure.

The object may be a solution that enables the chemical reactions of a battery. As an example, the object may be an electrolyte, a medium that facilitates the movement of lithium ions within a secondary battery.

However, the object is not limited to an electrolyte and may include other liquids, etc.

The body part 100 is the body of the supply tank 1, and may be formed as a single unit with an internal storage space configured to accommodate the object.

The body part 100 may be provided as a closed system to prevent moisture in the external air from coming into contact with the object, such as an electrolyte, thereby maintaining the quality of the object.

The body part 100 may have a water level detection part 101 on one side thereof so that a worker can visually check the storage amount of the object stored in the storage space from the outside.

The injection part 110 is connected to an electrolyte storage part (not shown) that stores the object such as an upstream electrolyte, and may receive the object from the electrolyte storage part and inject the object into the internal storage space of the body part 100.

The injection part 110 may include an injection part valve (not shown) to block or open a flow path connecting the electrolyte storage part and the storage space.

The discharge part 130 may discharge a portion of the object injected into the internal storage space of the body part 100 by the injection part 110, along with bubbles or the like contained in the object, to an external liquid storage part (not shown) for storing waste liquid, thereby removing bubbles generated during the injection of the object.

The discharge part 130 may include a discharge part valve 131 to block or open a flow path of the discharge part 130.

The supply part 120 may supply the object stored in the internal storage space of the body part 100 to the next process, such as the process of injecting electrolyte into the interior of a secondary battery in secondary battery manufacturing.

The supply part 120 may include a supply part valve (not shown) to block or open a flow path connecting the storage space and the next process.

The injection part 110, the supply part 120, and the discharge part 130 may be connected to each other downstream of a single vertical flow path connected to the internal storage space of the body part 100.

In addition, in the single vertical flow path, the supply part 120 may be located downstream of the injection part 110, and the discharge part 130 may be located downstream of the supply part 120.

The injection part 110 is positioned closest to the internal storage space of the body part 100 so as to minimize the path through which the object is injected into the internal storage space.

The discharge part 130 is positioned at the end directly connected in a straight line from the single vertical flow path, facilitating the discharge of the object from the internal storage space of the body part 100 to the outside.

As previously described, according to the supply tank 1 according to an embodiment of the present disclosure, since the injection part 110, the supply part 120, and the discharge part 130 are connected by means of the single vertical flow path, it is possible to simplify the structure and reduce parts, making manufacturing easier and reducing manufacturing costs.

The pressure maintenance valve 140 may maintain the pressure of the internal storage space of the body part 100, which is a closed system, at a constant level with the external pressure, which is the atmospheric pressure.

That is, the pressure maintenance valve 140 maintains the internal pressure of the storage space at the same as the external atmospheric pressure, enabling the stored object to be discharged in a precise, metered manner when released.

The pressure maintenance valve 140 may be opened together with the supply part 120 when supplying the object stored in the storage space to the next process.

As previously described, the pressure maintenance valve 140 may control the internal pressure of the storage space to be maintained at the same level as the external, atmospheric pressure while the object is injected into the internal storage space of the body part 100 through the injection part 110.

In addition, the pressure maintenance valve 140 may control the internal pressure of the storage space to be maintained at the same level as the external, atmospheric pressure while the object is discharged to the next process through the supply part 120.

In addition, the pressure maintenance valve 140 may be opened together with the discharge part 130 when discharging the object stored in the storage space to the outside of the storage space.

In addition, the pressure maintenance valve 140 may control the internal pressure of the storage space to be maintained at the same level as the external, atmospheric pressure while the object in the storage space is discharged to the external waste liquid storage part through the discharge part 130.

The pressure maintenance valve 140 may include a first flashback arrestor 141.

The first flashback arrestor 141 may be provided on the flow path of the pressure maintenance valve 140.

The first flashback arrestor 141 may block external flames from entering the storage space along the flow path of the opened pressure maintenance valve 140.

The first flashback arrestor 141 is provided on the flow path of the pressure maintenance valve 140, and may conduct heat away from the flame front, thereby removing heat and extinguishing the flame.

The first flashback arrestor 141 may be a metal mesh or fine membrane provided on the flow path of the pressure maintenance valve 140.

The first flashback arrestor 141 may rapidly remove heat through heat conduction when a high-temperature flame contacts the wall surfaces of the thin membrane of a first heat-conducting part.

The flame, with heat removed by the first flashback arrestor 141, may be cooled to a temperature of 30° C. or below.

In other words, the temperature of the ignition source decreases, combustion ceases, and the flame can be extinguished because the rate of generation of the molecules necessary for the reaction is lower than the rate of their loss.

The first flashback arrestor 141 may be selected from a metal mesh type, a flat plate type, or a water-cooled type.

The safety valve 150 may lower the internal pressure of the storage space when a rapid pressure increase occurs, for example, due to a fire inside or outside the storage space.

The safety valve 150 is normally closed and opens when the set pressure (5 kPa) or higher corresponds to a rapid pressure increase, thereby allowing the storage space to be connected to the outside.

The safety valve 150 opens when the pressure exceeds the set value and reduces the pressure in the storage space to normal levels, thereby preventing safety incidents such as failure or explosion of the supply tank 1 due to an overpressure condition.

In addition, the safety valve 150 may include a second flashback arrestor 151.

A second flashback arrestor 151 may be provided on the flow path of the safety valve 150.

The second flashback arrestor 151 may block external flames from entering the storage space along the flow path of the opened safety valve 150.

The second flashback arrestor 151 is provided on the flow path of the safety valve 150, and may conduct heat away from the flame front, thereby removing heat and extinguishing the flame.

The second flashback arrestor 151 may be a metal mesh or fine membrane provided on the flow path of the safety valve 150.

The second flashback arrestor 151 may rapidly remove heat through heat conduction when a high-temperature flame contacts the wall surfaces of the thin membrane of a second heat-conducting part.

The flame, with heat removed by the second flashback arrestor 151, may be cooled to a temperature of 30° C. or below.

In other words, the temperature of the ignition source decreases, combustion ceases, and the flame can be extinguished because the rate of generation of the molecules necessary for the reaction is lower than the rate of their loss.

The second flashback arrestor 151 may be selected from a metal mesh type, a flat plate type, or a water-cooled type.

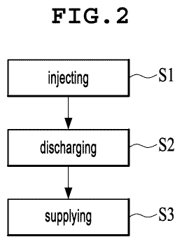

FIG. 2 is a flowchart showing a method for operating a supply tank according to an embodiment of the present disclosure.

As shown in FIG. 2, the method for operating the supply tank according to an embodiment of the present disclosure may include: injecting S1 an object into an internal storage space of a body part 100 after opening an injection part 110 and a pressure maintenance valve 140; discharging S2 a portion of the object stored in the storage space to the outside to remove bubbles in a state where a discharge part 130 is open while the injection part 110 is closed and the pressure maintenance valve 140 is kept open from the injection step S1; and supplying S3 the object stored in the storage space to the next process in a state where a supply part 120 is open while the discharge part 130 is closed and the pressure maintenance valve 140 is kept open from the discharge step S2.

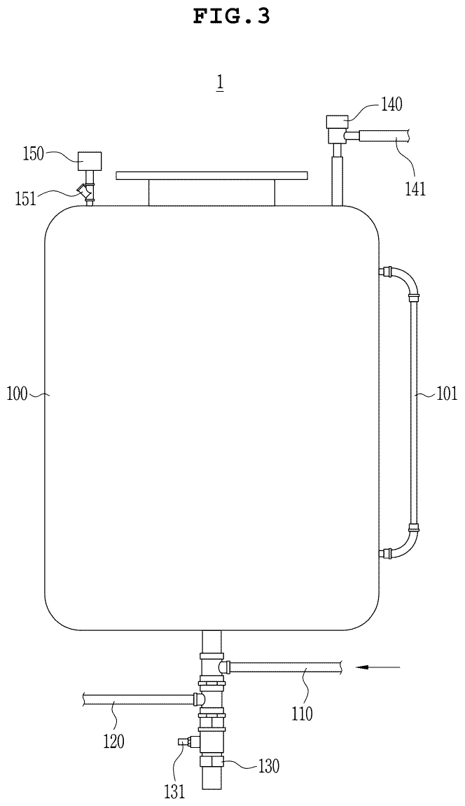

FIG. 3 is a view showing an injection step in the method for operating the supply tank according to an embodiment of the present disclosure.

Referring to FIG. 3, the injection step S1 may be a step of injecting the object from an external electrolyte storage part, etc., into the internal storage space of the body part 100 through the injection part 110.

In the injection step S1, the injection part 110 is opened with the supply part 120 and the discharge part 130 closed, and the pressure maintenance valve 140, which opens in conjunction with the injection part 110 is opened, enabling the object to be stored in the internal storage space of the body part 100.

Accordingly, the pressure maintenance valve 140 may maintain the pressure of the internal storage space of the body part 100 at the same level as the external, atmospheric pressure while the object is stored in the internal storage space of the body part 100.

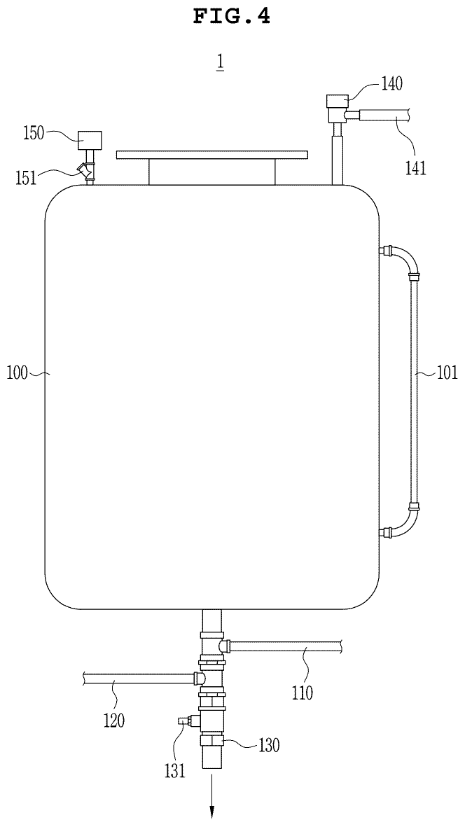

FIG. 4 is a view showing a discharge step in a method for operating a supply tank according to an embodiment of the present disclosure.

Referring to FIG. 4, the discharge step S2 may be a step in which a portion of the object containing bubbles injected into the storage space in the injection step S1 is discharged to an external waste liquid storage part to remove bubbles generated during injection from the object.

In the discharge step S2, the pressure maintenance valve 140 and the discharge part 130 are opened, with the injection part 110 closed from the injection step S1.

Thus, in the discharge step S2, while discharging the object stored in the internal storage space through the discharge part 130, the pressure of the storage space is maintained at the same level as the external, atmospheric pressure by the pressure maintenance valve 140 so that the object to be discharged is discharged in a precise, metered manner when released.

In addition, in the discharge step S2, in case that flames generated outside the body part 100, such as by a fire, enter a flow path of the pressure maintenance valve 140, a first flashback arrestor 141 provided in the flow path may reduce the flame temperature and extinguish the flames.

That is, the first flashback arrestor 141 may suppress external flames entering the flow path of the pressure maintenance valve 140, preventing the flames from flowing into the storage space via the pressure maintenance valve 140.

A safety valve 150 opens when the pressure exceeds a set pressure corresponding to a rapid pressure increase, thereby preventing the occurrence of an accident, such as a malfunction or explosion of the supply tank 1.

In addition, the safety valve 150 may be closed when the internal pressure of the storage space of the body part 100 or the external pressure is below the set pressure, thereby maintaining the internal storage space of the body part 100 as a closed system.

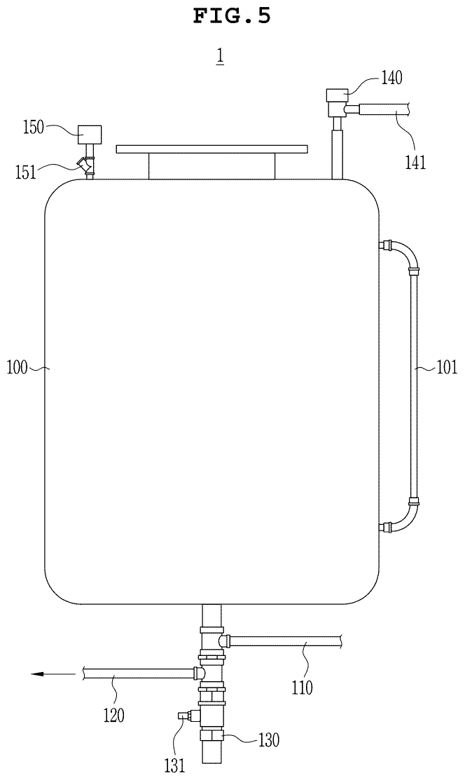

FIG. 5 is a view showing a supply step in a method for operating a supply tank according to an embodiment of the present disclosure.

Referring to FIG. 5, the supply step S3 may be a step for supplying the object stored in the storage space to the next process, such as the process of injecting electrolyte into the interior of a secondary battery in secondary battery manufacturing, through the supply part 120 after the discharge step S2.

In the supply step S3, the supply part 120 is opened, with the discharge part 130 closed and the pressure maintenance valve 140 kept open from the discharge step S2, to allow the object stored in the storage space to be supplied to the next process.

Thus, in the supply step S3, the object stored in the storage space is supplied to the next process through the supply part 120, while the pressure of the storage space is maintained at the same level as the external, atmospheric pressure by the pressure maintenance valve 140, so that the object supplied to the next process may be discharged in a precise, metered manner when released.

In addition, in the supply step S3, in case that a flame enters a flow path of the pressure maintenance valve 140 from the outside of the body part 100, the first flashback arrestor 141 provided in the flow path may lower the temperature of the flame and extinguish the flame.

The first flashback arrestor 141 may extinguish external flames penetrating into the flow path of the pressure maintenance valve 140 and prevent the flames from entering the storage space via the pressure maintenance valve 140.

In addition, according to the method for operating the supply tank according to the present disclosure, safety valve 150 may open when the internal pressure of the storage space of the body part 100 or the external pressure exceeds the set pressure, thereby lowering the pressure of the storage space.

The safety valve 150 opens when the pressure exceeds the set pressure corresponding to a rapid pressure increase, thereby preventing the occurrence of an accident, such as a malfunction or explosion of the supply tank 1.

In addition, the safety valve 150 may be closed when the internal pressure of the storage space of the body part 100 or the external pressure is below the set pressure, thereby maintaining the internal storage space of the body part 100 as a closed system.

In case that a flame enters a flow path of the safety valve 150 from outside of the body part 100, a second flashback arrestor 151 provided on the flow path of the safety valve 150 may lower the temperature of the flame and extinguish the flame.

In the event of a fire, the second flashback arrestor 151 may prevent flames from entering the flow path of the safety valve 150, thus preventing the flames from flowing into the storage space through the flow path.

Above, the present disclosure has been described in detail through specific embodiments. The embodiments are for specifically explaining the present disclosure, and are only illustrative and do not limit the scope of the appended claims. It is obvious to those skilled in the art that various changes and modifications to the embodiments are possible within the scope and technical idea of the present disclosure, and it is natural that such changes and modifications fall within the scope of the appended claims.

What is claimed is:

1. A supply tank comprising:
a body part configured to have a closed storage space inside;
an injection part configured to communicate with the storage space and inject an object into the storage space;
a supply part configured to communicate with the storage space and supply the object stored in the storage space to a next process;
a discharge part configured to communicate with the storage space and discharge the object stored in the storage space to outside;
a pressure maintenance valve connected to the storage space and configured to open or close in conjunction with one of the injection part, the supply part, and the discharge part; and
a safety valve connected to the storage space, and configured to open above a set pressure and close below the set pressure.

2. The tank of claim 1, wherein the pressure maintenance valve maintains a pressure of the storage space at a constant level.

3. The tank of claim 1, further comprising:
a first flashback arrestor provided on a flow path of the pressure maintenance valve, and configured to prevent external flames from entering the flow path of the pressure maintenance valve.

4. The tank of claim 3, wherein the first flashback arrestor is provided on the flow path of the pressure maintenance valve, and extinguishes flames that come into contact therewith by conducting heat away from the flames.

5. The tank of claim 1, further comprising:
a second flashback arrestor provided on a flow path of the safety valve, and configured to prevent external flames from entering the flow path of the safety valve.

6. The tank of claim 5, wherein the second flashback arrestor is provided on the flow path of the safety valve, and extinguishes flames that come into contact therewith by conducting heat away from the flames.

7. A method for operating a supply tank, the method comprising:
injecting an object into an internal storage space of a body part after opening an injection part and a pressure maintenance valve;
discharging a portion of the object stored in the storage space to outside to remove bubbles in a state where a discharge part is open, with the injection part closed and the pressure maintenance valve kept open from the injecting of the object; and
supplying the object stored in the storage space to a next process in a state where a supply part is open, with the discharge part closed and the pressure maintenance valve kept open from the discharging of the portion of the object.

8. The method of claim 7, wherein when an internal pressure of the storage space of the body part exceeds a set pressure, a safety valve opens to lower the pressure of the storage space.

9. The method of claim 8, wherein when the internal pressure of the storage space of the body part is below the set pressure, the safety valve is closed.

10. The method of claim 8, wherein in case that a flame enters a flow path of the safety valve from outside the body part, a second flashback arrestor provided on the flow path lowers temperature of the flame to extinguish the flame.

11. The method of claim 7, wherein in case that a flame enters a flow path of the pressure maintenance valve from outside the body part, a first flashback arrestor provided on the flow path lowers temperature of the flame to extinguish the flame.
